(19) United States
(12) Patent Application Publication
(10) Pub. No.: US 2008/0152420 A1
(43) Pub. Date: Jun. 26, 2008

(54) External fluid source fillable writing instrument

(76) Inventor: Yair Greenberg, Woodland Hills, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/642,248

(22) Filed: Dec. 20, 2006

(51) Int. Cl. B43K 5/02

(52) U.S. Cl. 401/222

(57) ABSTRACT

A writing instrument, able to be filled with fluid from an external fluid source, and to be supplied with fluid from an internal fluid supply for enabling writing therewith. The writing instrument includes a body portion, which includes a point portion, including a tip portion, through which fluid is able to flow to enable filling of the writing instrument from the external fluid source and writing with fluid from the internal fluid supply, and a fluid filling element, able to be actuated to enable filling thereof from the external fluid source. The writing instrument also includes a housing, connectable to and disconnectable from the tip portion, for enclosing the fluid filling element upon connection to the tip portion, and for enabling access to the fluid filling element for operation upon disconnection from the tip portion. The tip portion further includes a rollerball, for enabling writing therewith.

### BACKGROUND OF THE INVENTION

1. Field of the Invention

This invention is generally related to writing instruments, and more particularly, to a writing instrument which includes an internal supply which is fillable, and which is able to be supplied by the internal supply for enabling writing therewith.

2. General Background and State of the Art

A writing instrument such as a pen is a tool used for writing or drawing with a colored fluid such as ink.

A type of pen includes an internal reservoir for the ink, and a mechanism for feeding ink to a point for enabling writing therewith, using capillary action.

However, the ink may flow unevenly. Also, the ink may be slow to dry, in that the ink is exposed to air while flowing through the pen, so that it cannot dry quickly or it would clog the pen. Further, if the ink dries in the pen, in gums up the pen and requires careful cleaning.

Therefore, there has been identified a continuing need to provide a writing instrument for enabling filling fluid from an external fluid source, and supplying fluid to the tip of the writing instrument for enabling writing therewith.

### INVENTION SUMMARY

Briefly, and in general terms, the present invention, in a preferred embodiment, by way of example, is directed to a writing instrument, able to be filled with fluid from an external fluid source, and to be supplied with fluid from an internal fluid supply after filling thereof for enabling writing therewith. The writing instrument includes a body portion which includes a point portion, including a tip portion, through which fluid is able to flow to enable filling of the internal fluid supply of the writing instrument with fluid from the external fluid source therethrough and writing with fluid from the internal fluid supply therethrough. Also, the writing instrument includes a fluid filling element, able to be actuated to enable filling of the internal fluid supply from the external fluid source through the tip portion. The writing instrument further includes a housing, connectable to and disconnectable from the tip portion of the body portion, for enclosing the fluid filling element therein upon connection thereof to the tip portion, and for enabling access to the fluid filling element for operation thereof upon disconnection from the tip portion.

In accordance with other aspects of the invention, there is further provided a writing instrument which includes a tip portion including a rollerball, for enabling writing therewith.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a perspective view of a writing instrument and an external fluid supply in the present invention;

FIG. 2 is an exploded view of the cup, housing, and body portions of the writing instrument;

FIG. 3 is a perspective view of the filling operation of the writing instrument in accordance with aspects of the present invention;

FIG. 4 is an elevational cross-sectional view of the body portion of the writing instrument;

FIG. 5 is a fragmentary elevational cross-sectional view of the rollerball, tip portion, and point portion of the writing instrument in the filling operation of the writing instrument.

### DETAILED DESCRIPTION OF THE PREFERRED EMBODIMENTS

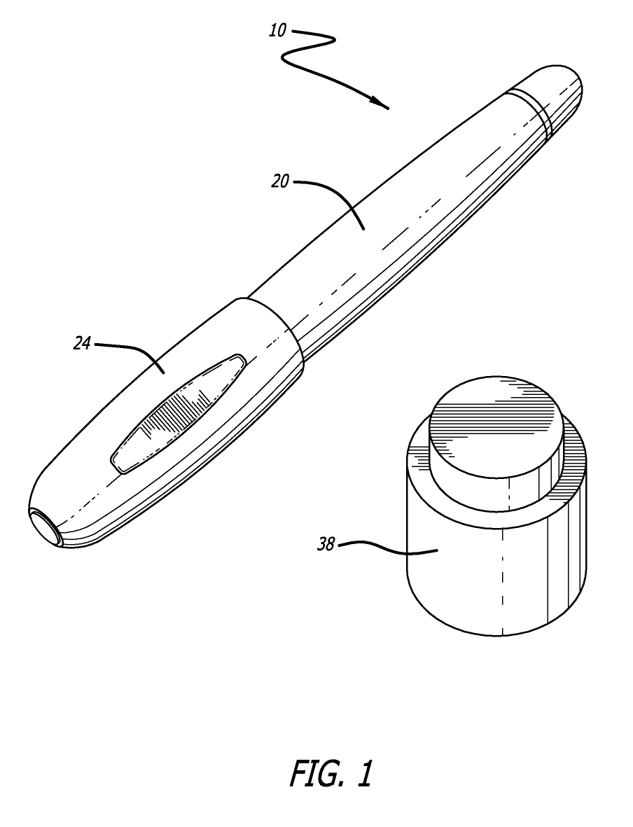

The writing instrument of the invention, as described herein and illustrated in FIGS. 1-5, is able to be filled with fluid from an external fluid source, and to be supplied with fluid from an internal fluid supply after filling thereof for enabling writing therewith.

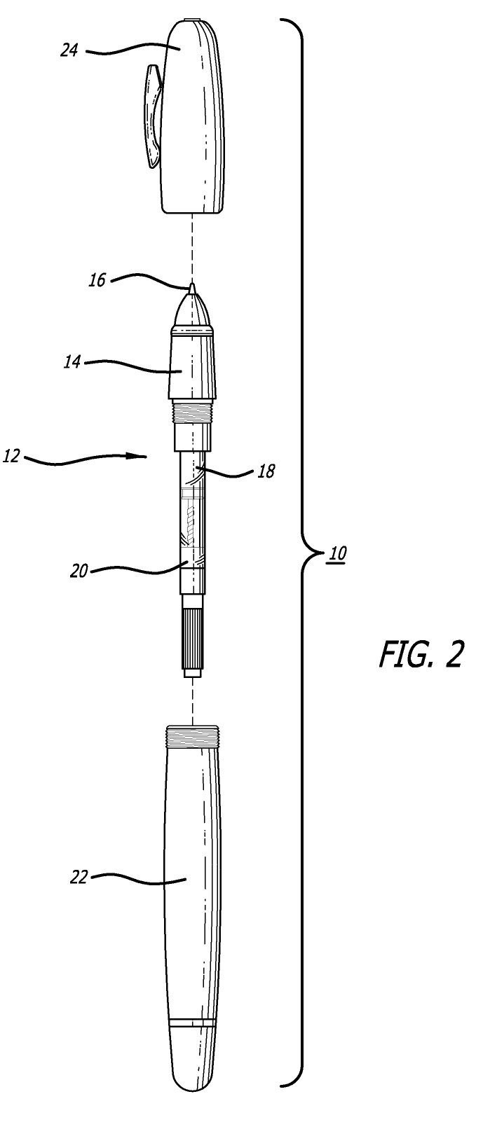

The writing instrument 10, as illustrated in FIGS. 1-2, includes a body portion 12, which includes a point portion 14, including a tip portion 16, through which fluid is able to flow to enable filling of an internal fluid supply 18 of the writing instrument 10 with fluid from the external fluid source therethrough and writing with fluid from the internal fluid supply 18 therethrough. The body portion 12 of the writing instrument 10 also includes a fluid filling element 20, able to be actuated to enable filling of the internal fluid supply 18 from the external fluid source through the tip portion 16. Further, the writing instrument 10 includes a housing 22, connectable to and disconnectable from the tip portion 16, for enclosing the fluid filling element 20 therein upon connection thereof to the tip portion 16, and for enabling access to the fluid filling element 20 for operation thereof upon disconnection from the tip portion 16. The writing instrument 10 further includes a cap 24, positionable upon and removable from the housing 22.

The tip portion 16 of the writing instrument point portion 14, as seen in FIG. 5, includes a rollerball 26, for enabling writing therewith. The point portion 14 has a longitudinal channel 28 extending therein substantially the length thereof and through and opening at the tip portion 16 and the rollerball 26, through which fluid may be drawn for filling the internal fluid supply 18 for supplying fluid through the tip portion 16, and through which fluid may be supplied to the rollerball 26, for enabling writing therewith.

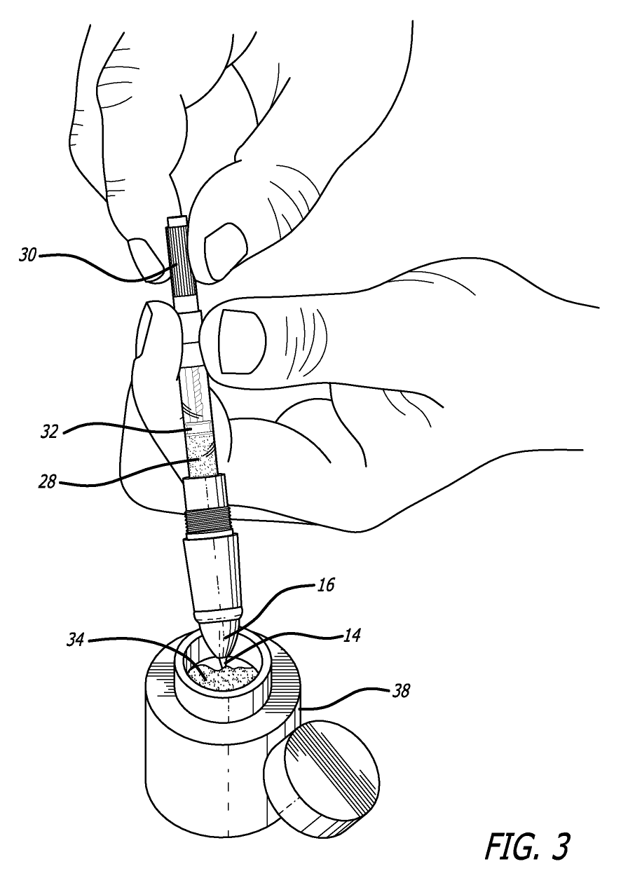

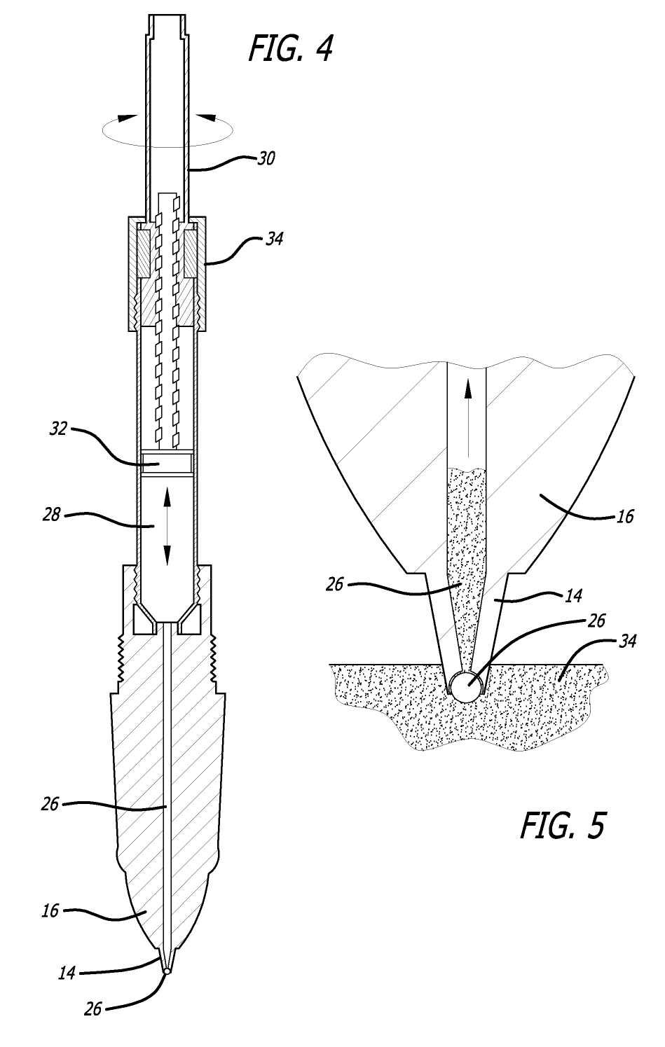

The fluid filling element 18 includes the internal fluid supply 18, and is able to be filled with fluid upon operation of the fluid filling element 20 and to supply fluid to the tip portion 16. The fluid filling element 30 further includes a plunger portion 32 which extends in the internal fluid supply 18, which includes a twistable portion 34. Referring to FIGS. 3-4, upon disconnection of the housing 22 from the point portion 14, which enables access to the fluid filling element 20, and upon twisting of the twistable portion 34, the plunger portion 32 may be rotated in a first direction so as to move in the direction of the tip portion 16 to push air out of the tip portion. The tip portion 16 may be dipped in the external fluid source, and the plunger portion 32 may be rotated in a second direction to draw suction in and to enable fluid to be drawn from the external fluid source through the tip portion 16 into the internal supply portion 18. The internal fluid supply 18 opens into the longitudinal channel 28 of the point portion 14.

The fluid 36 for filling the writing instrument 10 and for enabling writing therewith may comprise ink, and the external fluid source 38 for enabling filling of the internal fluid supply 18 in the writing instrument 10 may comprise an inkwell.

While the particular writing instrument as shown and disclosed in detail herein is fully capable of obtaining the objects and providing the advantages previously stated, it is to be understood that it is merely illustrative of the presently preferred embodiment of the invention, and that no limitations are intended to the details of construction or design shown herein other than as described in the appended claims.

I claim:

1. A writing instrument, able to be filled with fluid from an external fluid source, and to be supplied with fluid from an internal fluid supply after filling thereof for enabling writing therewith, comprising:
a body portion, which includes a point portion, including a tip portion, through which fluid is able to flow to enable filling of the internal fluid supply of the writing instrument with fluid from the external fluid source therethrough and writing with fluid from the internal fluid supply therethrough; and a fluid filling element, able to be actuated to enable filling of the internal fluid supply from the external fluid source through the tip portion; and
a housing, connectable to and disconnectable from the tip portion of the body portion, for enclosing the fluid filling element therein upon connection thereof to the tip portion, and for enabling access to the fluid filling element for operation thereof upon disconnection from the tip portion.

2. A writing instrument as in claim 1, wherein the tip portion includes a rollerball, for enabling writing therewith.

3. A writing instrument as in claim 1, wherein the fluid filling element includes a the internal fluid supply, able to be filled with fluid upon operation of the fluid filling element and to supply fluid to the tip portion.

4. A writing instrument as in claim 1, wherein the point portion has a longitudinal channel extending therein substantially the length thereof and through and opening at the tip portion thereof, through which fluid may be drawn through the tip portion for filling the internal fluid supply through the tip portion, and through which fluid may be supplied for enabling writing therewith.

5. A writing instrument as in claim 1, wherein the fluid for enabling writing therewith comprises ink.

6. A writing instrument as in claim 1, further comprising a cap portion, positionable upon and removable from the housing.

7. A writing instrument as in claim 2, wherein the point portion has a longitudinal channel extending therein substantially the length thereof and through and opening at the tip portion thereof, through which fluid may be drawn through the tip portion for filling the internal fluid supply through the tip portion, and through which fluid may be supplied to the rollerball for enabling writing therewith.

8. A writing instrument as in claim 3, wherein the fluid filling element further includes a plunger portion which extends in the internal fluid supply, which includes a twistable portion, whereby, upon disconnection of the housing from the point portion, enabling access to the fluid filling element, and upon twisting of the twistable portion, the plunger portion may be rotated in a first direction so as to move in the direction of the tip portion to push air out of the tip portion, the tip portion may be dipped in the external fluid source, and the plunger portion may be rotated in a second direction to draw suction in and to enable fluid to be drawn from the external fluid source through the tip portion into the internal fluid supply.

9. A writing instrument as in claim 4, wherein the internal fluid supply opens into the longitudinal channel of the point portion.

10. A writing instrument as in claim 5, wherein the external fluid source for enabling filling of the internal fluid supply in the writing instrument comprises an inkwell.

11. A method of enabling writing with a writing instrument, which is able to be filled with fluid from an external fluid source and to be supplied with fluid from an internal fluid supply after filling thereof, for enabling writing therewith, in connection with a writing instrument which comprises a body portion, which includes a point portion, including a tip portion, through which fluid is able to flow to enable filling of the internal fluid supply of the writing instrument with fluid from the external fluid source therethrough and writing with fluid from the internal fluid supply therethrough, and a fluid filling element, able to be actuated to enable filling of the internal fluid supply from the external fluid source through the tip portion, and a housing, connectable to and disconnectable from the tip portion of the body portion, for enclosing the fluid filling element therein upon connection thereof to the tip portion, and for enabling access to the fluid filling element for operation thereof upon disconnection from the tip portion, wherein the method comprises:
enabling disconnection of the housing from the tip portion, and enabling filling of the internal fluid supply of the writing source through the tip portion of the body portion, including actuating the fluid filling element; and
enabling supplying fluid from the internal fluid supply after filling thereof for enabling writing therewith.

12. A method as in claim 11, wherein the tip portion includes a rollerball, for enabling writing therewith, and wherein enabling writing in the method further comprises enabling writing with the rollerball.

13. A method as in claim 11, wherein the fluid filling element includes a fluid supply portion, able to be filled with fluid upon operation of the fluid filling element and to supply fluid to the tip portion, and wherein enabling filling in the method further comprises enabling filling of the fluid supply portion, and enabling supplying in the method further comprises enabling supplying from the internal fluid supply.

14. A method as in claim 11, wherein the point portion has a longitudinal channel extending therein substantially the length thereof and through and opening at the tip portion thereof, through which fluid may be drawn through the tip portion for filling the internal fluid supply or for writing through the tip portion, and wherein enabling filling the method further comprises enabling filling through the longitudinal channel, and wherein enabling supplying in the method further comprises enabling supplying through the longitudinal channel.

15. A method as in claim 11, wherein the fluid for enabling writing therewith comprises ink, and wherein enabling writing in the method further comprises enabling writing with ink.

16. A method as in claim 11, wherein the writing instrument further comprises a cap portion, positionable upon and removable from the housing, and wherein the method further comprises enabling positioning of the cap portion on the housing, and enabling removal of the cap portion from the housing.

17. A method as in claim 12, wherein the point portion has a longitudinal channel extending therein substantially the length thereof and through and opening at the tip portion thereof, through which fluid may be drawn through the tip portion for filling the internal fluid supply through the tip portion, and through which fluid may be supplied to the rollerball for enabling writing therewith, and wherein enabling filling the method further comprises enabling filling through the longitudinal channel, and further comprising enabling writing with the rollerball with fluid supplied through the tip portion.

18. A method as in claim 13, wherein the fluid filling element further includes a plunger portion which extends in the internal fluid supply, which includes a twistable portion, whereby, upon disconnection of the housing from the point portion, enabling access to the fluid filling element, and upon twisting of the twistable portion, the plunger portion may be rotated in a first direction so as to move in the direction of the tip portion to push air out of the tip portion, the tip portion may be dipped in the external fluid source, and the plunger portion may be rotated in a second direction to draw suction in and to enable fluid to be drawn from the external fluid source through the tip portion into the internal fluid supply, and wherein enabling filling in the method further comprises rotating the plunger portion in a first direction so as to move in the direction of the tip portion, and rotating the plunger portion in a second opposite direction to enable fluid to be drawn through the tip portion into the internal fluid supply.

19. A method as in claim 13, wherein the internal fluid supply opens into the longitudinal channel of the point portion, and wherein enabling filling in the method further comprises enabling filling through the longitudinal channel, and enabling supplying in the method further comprises enabling supplying through the longitudinal channel.

20. A method as in claim 15, wherein the external fluid source for enabling filling of the internal fluid supply in the writing instrument comprises an inkwell, and wherein enabling writing in the method further comprises enabling writing with ink filled from the inkwell.
